(19) United States
(12) Patent Application Publication
(10) Pub. No.: US 2015/0032641 A1
(43) Pub. Date: Jan. 29, 2015

(54) SYSTEM AND METHOD FOR OBTAINING INDICATION INFORMATION

(71) Applicant: A. O. Smith Corporation, Milwaukee, WA (US)

(72) Inventors: Wei Ding, Nanjing (CN); Guobin Yang, Nanjing (CN)

(21) Appl. No.: 14/331,965

(22) Filed: Jul. 15, 2014

(30) Foreign Application Priority Data
Jul. 29, 2013 (CN) 201310322971.3
Sep. 4, 2013 (CN) 201310398261.9

(51) Int. Cl. G06Q 30/00

(52) U.S. Cl. CPC G06Q 30/016
USPC 705/304

(57) ABSTRACT

Provided in the present invention is a system and a method for obtaining indication information. The system comprises: a product device including a control part for obtaining product status information and generating a product status identification based on the same; an information collection part for collecting the product status identification; an information transceiving part for transmitting the product status identification to a server and receiving service information returned from the server; and the server which includes a receiving part for receiving the product status identification transmitted by the information transceiving part, an information processing part for obtaining corresponding service information according to the product status identification, and a transmitting part for returning the service information to the information transceiving part. By virtue of the embodiments of the present invention, users are enabled to conveniently obtain service information in line with the use habit without the need of spending plenty of time to analyze the configuration, and with a low cost.

### TECHNICAL FIELD

The present application relates an electrical apparatus, and more particularly, to a system and a method for obtaining indication information.

### BACKGROUND ART

Along with the widespread application of high technology, the development of intelligent products is also gradually accelerated. Functions of the product are becoming richer, and applicable to more and more application scenarios.

Chinese Patent Application No. CN101329740A discloses a wireless radio frequency household electrical appliance client network centralized management terminal system, the storage information of electronic tags of the apparatus is read by a handheld radio frequency read-write terminal. The storage information and the relevant database information of a central server are synchronously uploaded and downloaded through a network. The handheld radio frequency read-write terminal has a transaction history inquiry module that can query and list the history information of the transaction in a certain inquiry time period in the apparatus corresponding to the data read by the handheld radio frequency read-write terminal, organize and summarize the information of the apparatus such as name, model, number, unit price of sold goods within a certain time period, and display them before a user.

### SUMMARY OF THE INVENTION

As intelligent products have plenty of functions, and many application scenarios, and the setting thereof is relatively complicated, it can be time consuming for a user to set the purchased product to meet his/her own requirements. In addition, in the prior art (CN101329740A), a dedicated radio frequency read-write terminal is required to obtain information associated with product usage. Therefore, additional implementation cost is further required.

Hence, embodiments of the present invention provide a system and a method for obtaining indication information, whereby indication information associated with product usage can be conveniently and accurately obtained with low cost.

A first aspect of the embodiments of the present invention provides a system for obtaining indication information, comprising: a product device, including a control part for obtaining product status information and generating a product status identification based on the same; an information collection part, for collecting the product status identification generated by the control part; an information transceiving part, for transmitting the product status identification collected by the information collection part to a server, and receiving service information returned from the server; and the server, including a receiving part for receiving the product status identification transmitted by the information transceiving part, an information processing part for obtaining corresponding service information according to the product status identification, and a transmitting part for returning the service information to the information transceiving part.

A second aspect of the embodiments of the present invention provides a method for obtaining indication information, comprising: obtaining, by a control part of a product device, product status information, and generating a product status identification based on the same; collecting, by an information collection part, the product status identification generated by the control part; transmitting, by an information transceiving part, the product status identification to a server; and receiving, by the server, the product status identification transmitted by the information transceiving part, and obtaining corresponding service information according to the product status identification.

A third aspect of the embodiments of the present invention provides a system for obtaining indication information, comprising: a product device, including a control part for obtaining product status information and generating a product status identification based on the same; and an information transceiving part, for transmitting the product status identification to a server and receiving service information returned from the server; and the server, including a receiving part for receiving the product status identification transmitted by the information transceiving part, an information processing part for obtaining corresponding service information according to the product status identification, and a transmitting part for returning the service information to the information transceiving part.

A fourth aspect of the embodiments of the present invention provides a method for obtaining indication information, comprising: obtaining, by a product device, product status information, generating a product status identification based on the same, and transmitting the product status identification to a server; receiving, by the server, the product status identification transmitted by the product device and obtaining corresponding service information according to the product status identification, and returning, by the server, the obtained service information to the product device.

By virtue of the embodiments of the present invention, product users are enabled to conveniently obtain service information in line with the use habit without the need of spending plenty of time to analyze the configuration, and with low cost.

### BRIEF DESCRIPTION OF THE ACCOMPANYING DRAWINGS

The aforementioned features and advantages, as well as additional features and advantages of the present invention will become apparent from the following detailed description of the preferred embodiments given in conjunction with the accompanying drawings, in which:

FIG. 1 is a schematic diagram illustrating the structure of the system for obtaining indication information according to embodiment 1 of the present invention;

FIG. 2 is a schematic diagram illustrating the structure of the product device according to embodiment 1 of the present invention;

FIG. 3 is a schematic diagram illustrating the structure of the server according to embodiment 1 of the present invention;

FIG. 4 is a schematic diagram illustrating the structure of the information processing part of the server according to embodiment 1 of the present invention;

FIG. 5 is a schematic diagram illustrating the structure of the system for obtaining indication information according to embodiment 2 of the present invention;

FIG. 6 is a schematic diagram illustrating the structure of the system for obtaining indication information according to embodiment 3 of the present invention;

FIG. 7 is a schematic diagram illustrating the structure of the product device in the system according to embodiment 3 of the present invention;

FIG. 8 is a flowchart of the method for obtaining indication information according to embodiment 4 of the present invention;

FIG. 9 is a flowchart of the method for obtaining indication information according to embodiment 5 of the present invention;

FIG. 10 is a flowchart of the method for obtaining indication information according to embodiment 6 of the present invention;

FIG. 11 is a flowchart of the method for obtaining indication information according to embodiment 7 of the present invention;

FIGS. 12a to 12c are schematic diagrams illustrating stacked two-dimensional bar codes;

FIGS. 12d to 12f illustrate representative matrix two-dimensional bar codes.

### DETAILED DESCRIPTION OF PREFERRED EMBODIMENTS

Hereinafter, the present invention will be further described in detail with reference to the accompanying drawings. The description information provided in the specific embodiments and applications is merely exemplary in nature. Various extensions and combination of the embodiments described herein will be obvious to those skilled in the art. The general principles as defined in the present invention can be applied to other embodiments and applications without departing from the essence and scope of the invention. Therefore, the present invention is not limited to the embodiments as described, and covers the widest scope that is consistent with the principles and features as described herein.

Detailed description that follows is presented in terms of flowcharts, logic blocks, and other symbolic representations of operations that can be performed on a computer system. A program, computer-executed step, logic block, procedure, etc., are conceived here to be a self-consistent sequence of one or more steps or instructions leading to desired results. The steps are those utilizing physical manipulations of physical quantities. These physical quantities include electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

The product device in the embodiments of the present invention may be an electrical product, for example, an electrical equipment such as a water heater, an air conditioner, a refrigerator or the like; the terminal device includes all equipments such as communication apparatuses, personal digital assistants (PDAs), smartphones, portable communication apparatuses, or the like. However, the embodiments of the present invention should not be limited to the abovementioned product devices and terminal devices.

### Embodiment 1

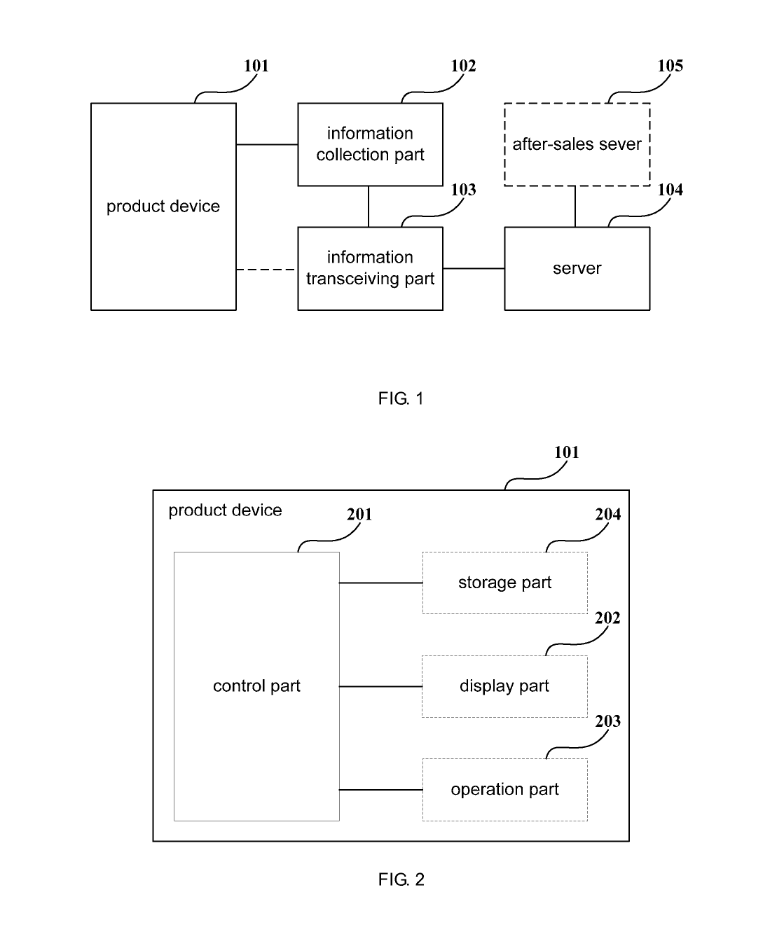

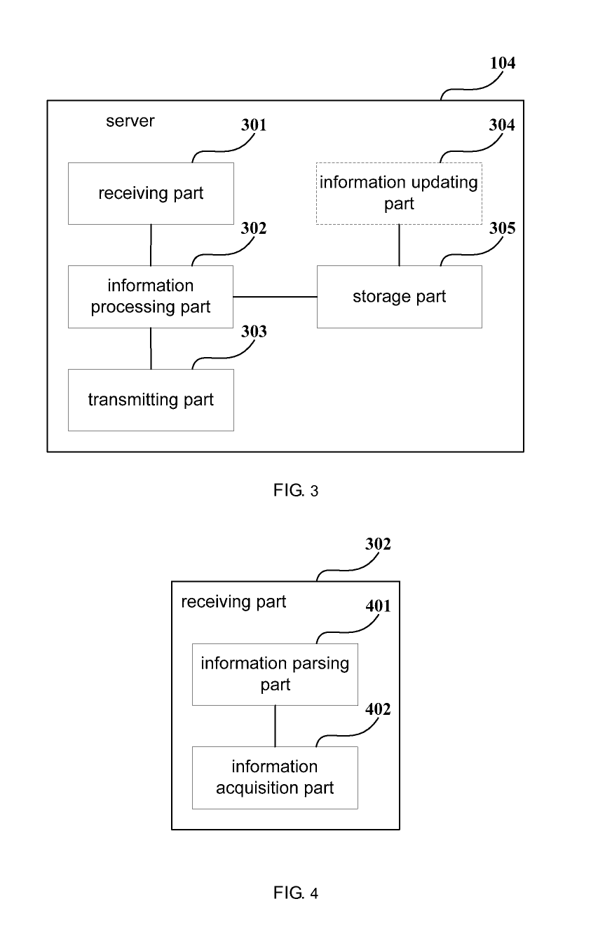

FIG. 1 is a schematic diagram illustrating the structure of the system for obtaining indication information according to embodiment 1 of the present invention; FIG. 2 is a schematic diagram illustrating the structure of the product device according to embodiment 1 of the present invention; FIG. 3 is a schematic diagram illustrating the structure of the server according to embodiment 1 of the present invention. Hereinafter, the system for obtaining indication information according to embodiment 1 of the present invention will be described in further detail below with reference to the accompanying drawings.

As illustrated in FIG. 1, the system comprises: a product device 101, an information collection part 102, an information transceiving part 103 and a sever 104.

As illustrated in FIG. 2, the product device 101 comprises a control part 201 for obtaining product status information and generating a product status identification based on the same.

The information collection part 102 is for collecting the product status identification generated by the control part 201.

The information transceiving part 103 is for transmitting the product status identification collected by the information collection part 102 to the server 104 and receiving service information returned from the server 104.

As illustrated in FIG. 3, the server 104 includes a receiving part 301 for receiving the product status identification transmitted by the information transceiving part 103, an information processing part 302 for obtaining corresponding service information according to the product status identification, and a transmitting part 303 for returning the service information to the information transceiving part 103.

In the present embodiment, the product status information obtained by the product device 101 may include one or more of the following information: configuration information, usage operation information, and detection information of the product.

In the present embodiment, the configuration information of the product may include one or more of the following information: official website of a company, product model, production shift, date of production, production date, batch number, functional parameters of the product device, production identification, usage time, etc, but is not limited to the above information.

In the configuration information of the product, the official website of the company, product model, production shift, date of production can be obtained before the product device leaves the factory, while other information can be recorded when a user uses the product device after the product device has been installed for the user. In addition, the product model may also be obtained when a user uses the product device after the product device has been installed for the user, and the production identification can also be obtained before the product device leaves the factory. Of these, the functional parameters of the product device are related to a type of the product device. For example, for a water heater, the functional parameter may be the number of Liter of the water heater; for a refrigerator, the functional parameter may be the capacity of the refrigerator, other electrical equipment has similar parameters that will not be and no repetition is made in this context.

In the present embodiment, the usage operation information may include one or more of the following information: function setting information, auxiliary function setting information and the like; for example, where the product device 101 is a water heater, the function setting information may include temperature setting information, and the auxiliary function setting may include timing setting information, the information of usage amount of hot water and the like. The usage operation information is the information recorded when the product device has been installed for the user and when the user uses the product device.

In the present embodiment, the detection information may comprise failure information, for example, where the product device 101 is a water heater, the failure information may be information on sensor failure, heating system information, and/or power source failure, and the like, but is not limited to the above information, and can include other information upon practical circumstances.

Thus, before the product device 101 leaves the factory and/or when a user uses the product device, it is possible to obtain and record the product status information. Accordingly, the control part of the product device 101 can obtain the product status information from the above information as recorded.

In the present embodiment, the product status identification generated by the product device 101 may be identification information corresponding to the service information of the product, for example, ID1, ID2, etc. For a product device of every model, it is possible to prestore the product status identification and service information in the server 104 correspondingly. Thus, the server 104 may directly look up in a database according to the identification information to find the service information, wherein the service information includes product usage information and/or forenotice information. The product usage information may be instruction information for instructing a user to operate the product device, such as prompting information and/or operation steps for operating the product device. In addition, the forenotice information may include maintenance forenotice information to prompt a user to maintain the product device.

In the present embodiment, the product status identification generated by the product device 101 may further be a one-dimensional code, a two-dimensional code and/or a three-dimensional code. Thus, when the information collection part (e.g., a camera device) collects the product status identification, it is possible to scan the one-dimensional code, the two-dimensional code and/or the three-dimensional code, and identify the same based on bar code technology, so as to obtain the product status information carried by the one-dimensional code, the two-dimensional code and/or the three-dimensional code. By taking this approach, a large amount of information can be provided with high recognition and low error rate. In this case, the server 104 first analyzes the received product status information, obtains corresponding analysis information, and then obtains the corresponding service information based on the analysis information.

The product status identification is not limited to the above formats, as the product status information can be further obtained by using other modes upon practical circumstances.

In the present embodiment, when a one-dimensional code, a two-dimensional code and/or a three-dimensional code are/is used to carry the product status information, the analysis information obtained by the server 104 is to refer to the information of the usage of the product device by a user, and/or device maintenance conditions. The service information obtained by the server 104 as related with the analysis information includes product usage information and/or forenotice information, wherein the product usage information of the user may include the information such as user's habit of usage. The product usage information is the usage information with respect the user, for example, instruction information for instructing a user to operate the product device, such as prompting information and/or operation steps. In addition, the forenotice information may include maintenance forenotice information to prompt a user to maintain the product device. In this case, for a product device of every model, it is possible to prestore the analysis information and service information in the server 104 correspondingly, for example, it is possible to prestore the analysis information (e.g., usage information and/or device maintenance information) and service information (e.g., prompting information, operation steps, and/or maintenance forenotice information) correspondingly. After obtaining the analysis information, the server 104 may look up the service information corresponding thereto in a database.

Hereinafter, explanation will be made by taking the product device 101 as a water heater with the production identification being a two-dimensional code as an example.

For instance, if the usage information (user's habit) in the analysis information is the rule as to when a user uses water, it is possible to obtain the corresponding service information (e.g., prompting information for prompting the user to use the reservation timing function); furthermore, it is possible to obtain the service information, for example, operation steps matching with the model of the water heater.

If the usage information (user's habit) indicates that water consumption by a user is relatively large, corresponding service information can be obtained, for example, prompting information for prompting the user to turn on the function of increasing hot water output and/or prompting the user to enhance the setting temperature so as to enhance the degree of comfortableness; furthermore, service information can further be obtained, for example, operation steps matching with the model of the water heater; if water consumption by a user is relatively small, corresponding service information can be obtained, for example, prompting information for prompting the user to shut down the function of increasing hot water output; furthermore, service information can further be obtained, for example, operation steps matching with the model of the water heater. When the setting parameter in the operation steps is related with the time when the water heater is used, it is also possible to match out the corresponding use operation steps according to the production date and model of the water heater.

For example, if the analysis information includes information on device maintenance situations, for example, information on failure alarm is happening or happened to the water heater before, the corresponding forenotice information can be obtained, for example, the forenotice information includes specific failure information and/or forenotice information for prompting the user to maintain the water heater.

The above product device 101 is explained by taking a water heater as an example, other product devices are similar to a water heater, and no repetition is made in this context.

Hereinafter, the structures of the product device 101 and the server 104 according to embodiment 1 of the present invention are explained with reference to the accompanying drawings.

FIG. 2 is a schematic diagram illustrating the structure of the product device according to embodiment 1 of the present invention. As illustrated in FIG. 2, the product device 101 comprises a control part 201 having the function as described above, for which no repetition is made.

In the present embodiment, the product device 101 further comprises a display part 202 for displaying the product status identification generated by the control part 201. Thus, displaying the product status identification by the display part 202 will make it easy to collect the product status information. The member is an optional member and is represented by a dashed box.

In the present embodiment, the display part 202 can be used to continuously display the above information, namely, display the above information in real time, or regularly display the above information at a predetermined time interval, or display the above information according to a display instruction.

In the case where the above information is displayed according to a display instruction, the product device 101 can further comprise an operation part 203 for example, an operation key or a mouse and the like, for inputting the display instruction, and the control part 201 controls the display part 202 to display the above information according to the display instruction inputted by the operation part 203. Thus, it is possible to display the related information only when a user needs to obtain the related information, and thus the amount of electricity consumed by the product device can be reduced. The operation part 203 is an optional member and is represented by a dashed box.

In this embodiment, the product device 101 can further comprise a storage part 204 that stores the aforementioned product status information and/or product status identification. This member is an optional member and is represented by a dashed box.

FIG. 3 is a schematic diagram illustrating the structure of the server according to embodiment 1 of the present invention. As illustrated in FIG. 3, the server 104 comprises a receiving part 301, an information processing part 302 and a transmitting part 303 having functions as described above, for which no repetition is made.

When the product status identification generated by the product device 101 is the identification information corresponding to the service information of the product, the information processing part 302 may directly look up in a database based on the identification information to find the service information.

When the product status identification generated by the product device 101 is a one-dimensional code, a two-dimensional code and/or a three-dimensional code, the information processing part 302 is as illustrated in FIG. 4.

FIG. 4 is a schematic diagram illustrating the structure of the information processing part of the server according to embodiment 1 of the present invention. As illustrated in FIG. 4, the information processing part 302 comprises an information parsing part 401 for analyzing product status information according to the product status identification to obtain analysis information which includes usage habit of a user, of the product device and/or maintenance situation of the device; and an information acquisition part 402 for acquiring service information related to the analysis information, wherein the service information includes product usage information and/or forenotice information.

In the present embodiment, the information parsing part 401 obtains analysis information such as usage habit of a user, of the product device and/or maintenance situation of the device by analyzing the product status identification; the information acquisition part 402 acquires corresponding service information according to the analysis information. For example, it is possible to obtain corresponding prompting information according to the usage habit of the user, or look up in a database of the server 104 according to the product model or production identification, so as to obtain operation steps corresponding to the product device.

In the present embodiment, the server 104 may comprise a storage part 305 for storing service information corresponding to the product status identification, and/or service information corresponding to the analysis information.

In the present embodiment, if the information processing part 302 fails to find the corresponding service information, that is, the corresponding service information is not prestored in the server 104, the transmitting part 303 of the server 104 may transmit to an after-sales server (e.g., an artificial intelligence system) a message of obtaining no service information, transmit the product status identification or the analysis information to the after-sales server to allow related personnel to be informed of this situation, obtain a corresponding solution (i.e., service information) based on the product status identification or the analysis information, and store the solution in the server 104. The server 104 stores the service information to update the service information stored in the database.

In this case, the server 104 further comprises an information update part 304 for receiving the inputted solution (i.e., service information) when the information processing part 302 fails to obtain the corresponding service information to update the database storing the service information, wherein the inputted solution may be either a solution returned by the after-sales server or a solution inputted to the server 104 artificially. In the present embodiment, the after-sales server may be a remote server, which is an optional member and is represented by a dashed box. This member is not required when the server 104 can obtain the service information.

In the present embodiment, each device of the system may exchange information by a wireless network, for example, a 3G network or GPRS network in the manner of internet so that a user of the product device obtains relevant operation instructions, and the configuration and operation of the water heater being adaptable to the user's requirements can be realized at a low device implementation cost.

In the above embodiment, as illustrated in FIG. 1, the information collection part 102 is a separate device, for example, a camera device (e.g., camera); the information transceiving part 103 may also be a separate device, for example, an information transceiving device or a terminal device having an information transceiving function (e.g., a terminal device having an information transceiving function).

In addition, the information collection part 102 and the information transceiving part 103 may be arranged on one terminal device, for example, a terminal device such as a mobile phone, a PDA, a laptop computer.

In the case where the information transceiving part 103 is implemented by a terminal device having an information transceiving function, or the information transceiving part 103 and the information collection part 102 are implemented by a terminal device having information collection and transceiving functions, if the terminal device has a display part, the service information returned by the server 104 may be displayed on the terminal device, in which case, the service information received from the server 104 don't have to be returned to the product device 101, and the product device can read the above information at the terminal device directly. However, it is not limited to this, as it is also possible to return the service information to the product device 101, thereby providing convenience for the user.

In the case where the information transceiving part 103 is arranged in the product device 101, the service information returned by the server 104 is transmitted to the product device, and moreover, the display part 202 of the product device 101 can further display the service information, thereby providing convenience for the user in setting, operating the product device, and maintaining the product device. In addition, the storage part 204 of the product device 101 can also store the service information.

### Embodiment 2

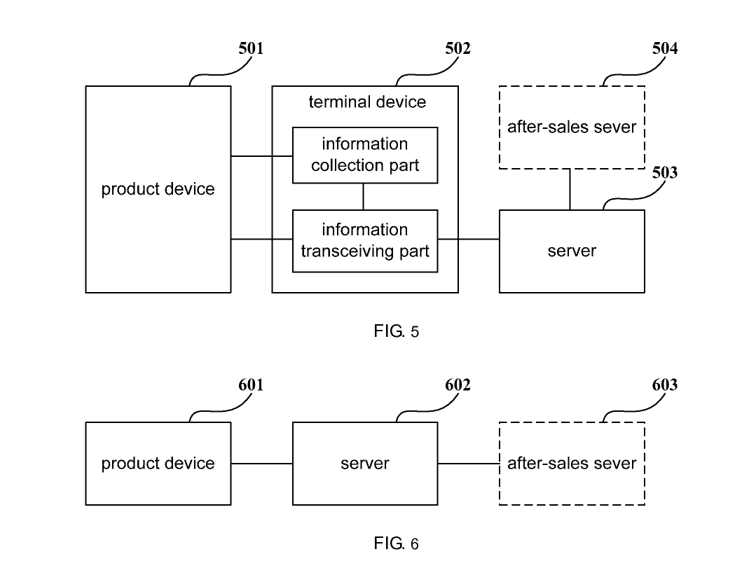

FIG. 5 is a schematic diagram illustrating the structure of the system for obtaining indication information according to embodiment 2 of the present invention. As illustrated in FIG. 5, the system comprises: a product device 501, a terminal device 502 and a server 503.

Based on embodiment 1, only the difference between the present embodiment and embodiment 1 will be described, while the similarities shared therebetween are not repeated herein.

In the present embodiment, both the information collection unit 102 and the information transceiving unit 103 as shown in FIG. 1 are arranged in one terminal device, for example, a mobile terminal. Thus, a user may perform information interaction by use of existing device to save cost. Accordingly, the terminal device may comprise the information collection part and the information transceiving part with the similar functions as those in embodiment 1. The related contents are incorporated herein, and no repetition is made.

In this case, the service information returned by the server 104 may be displayed on the terminal device for use. In addition, it is also possible to return the service information to the product device 101.

In the present embodiment, the system can further comprise an after-sales server 504 having similar functions as the after-sales server does in embodiment 1. The related contents are incorporated herein, and no repetition is made.

### Embodiment 3

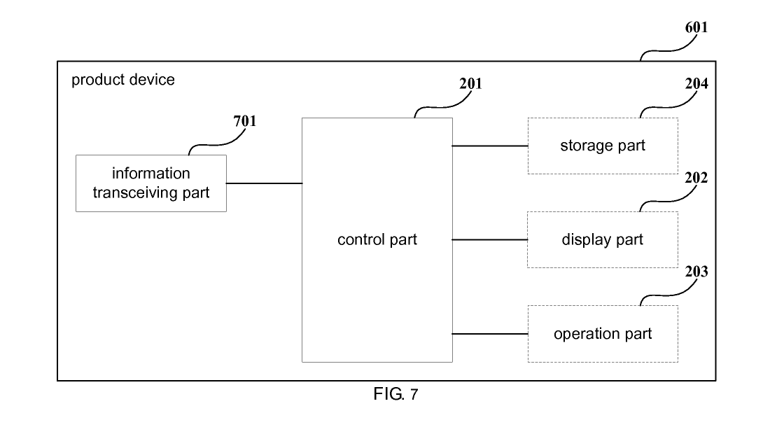

FIG. 6 is a schematic diagram illustrating the structure of the system for obtaining indication information according to embodiment 3 of the present invention; FIG. 7 is a schematic diagram illustrating the structure of the product device according to embodiment 3 of the present invention. As illustrated in FIG. 6, the system comprises: a product device 601 and a server 602.

Based on embodiment 1, only the differences between the present embodiment and embodiment 1 will be described, while the similarities shared therebetween are not repeated herein.

In the present embodiment, the information transceiving part 103 is disposed on the product device. Thus, the information transceiving part 701 can transmit product status identification generated by the product device 601 to the server 602, and receive the service information returned by the server 602. No information collection part is required, and thus device cost can be saved. As illustrated in FIG. 7, the product device can further comprise the information transceiving part 701 for transmitting the product status identification generated by the control part 201 to the server 602, and receiving the service information returned by the server 602.

In the present embodiment, the display part 202 of the product device 601 can further display the service information, and the storage part 204 can also store the service information.

In the present embodiment, the system can further comprise an after-sales server 603 having similar functions as the after-sales server does in embodiment 1. The related contents are incorporated herein, and thus no repetition is made.

Hereinafter, the method for obtaining indication information of embodiments of the present invention will be described in greater detail below with reference to the drawings.

### Embodiment 4

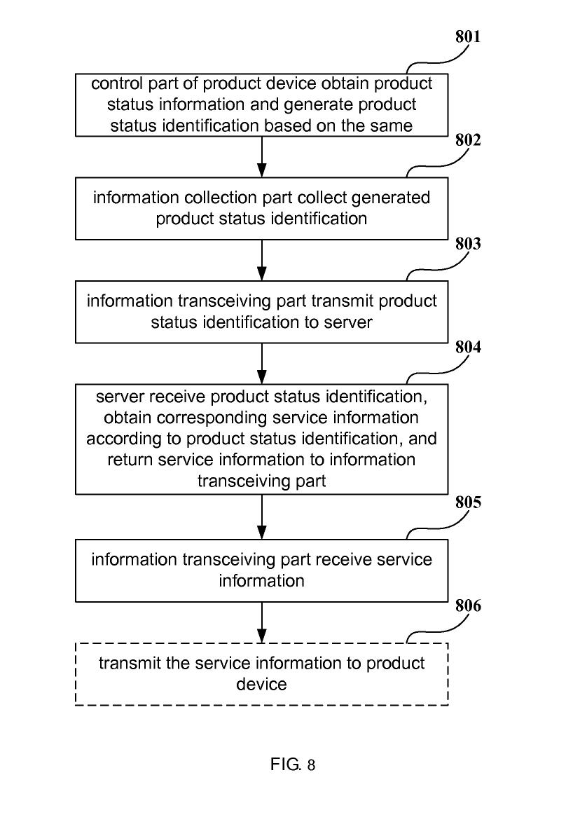

FIG. 8 is a flowchart of the method for obtaining indication information according to embodiment 4 of the present invention. As illustrated in FIG. 8, the method comprises:

Step 801, a control part of a product device obtains product status information and generates a product status identification based on the same.

In the present embodiment, the product status identification may be identification information corresponding to the service information or a one-dimensional code or a two-dimensional code or a three-dimensional code, as described in embodiment 1, and thus no repetition is made herein.

Step 802, an information collection part collects the product status identification generated by the control part.

Step 803, an information transceiving part transmits the product status identification to a server.

Step 804, the server receives the product status identification transmitted by the information transceiving part, obtains corresponding service information according to the product status identification, and returns the service information to the information transceiving part.

In the present embodiment, the server may look up corresponding service information in a database according to the product status identification; in addition, if the product status identification is a one-dimensional code or a two-dimensional code or a three-dimensional code, a large amount of information can be carried by the product status identification, in this case, the server may analyze the product status identification, obtain corresponding analysis information, and obtain corresponding service information according to the analysis information. See embodiment 1 for detail, and no repetition is made herein.

Step 805, the information transceiving part receives the service information.

In the present embodiment, when the information transceiving part is implemented by a terminal device, the service information can be displayed by a display part of the terminal device. Thus, a user of the terminal device may perform a corresponding operation based on the service information, thereby providing convenience for the user.

Step 806, the information transceiving part transmits the service information to the product device.

In the present embodiment, the information transceiving part can further forward the service information to the product device.

Thus, the user can also obtain the service information from the product device. This step is an optional step and is represented by a dashed box.

As can be known from the above embodiment, a user of the product device can obtain relevant operation instructions by means of information interaction between each device, and the configuration and operation of the water heater being adaptable to the user's requirements can be realized at low device implementation cost.

In the present embodiment, the product status information obtained by the product device, the generated production status identification, the analysis information obtained by the server, and corresponding service information are similar to those in embodiments 1-3. The related contents are incorporated herein, and thus no repetition is made.

In the present embodiment, the method may further comprise recording the product status information, for example, related information before the product device leaves the factory, and the usage operation information of a user equipment in usage.

In the present embodiment, the method may further comprise displaying, by a display part of the product device, the product status identification, and/or the service information. Thus, a user of the product device can perform a corresponding operation according to the displayed service information, wherein the product status identification, and/or the service information can be continuously or regularly displayed, or be displayed according to an instruction inputted by a user.

In the present embodiment, in Step 804, when the server 104 can not obtain the service information (e.g., operation step), the method may further comprise transmitting by the server 103 to an after-sales server (e.g., an artificial intelligence system), a message of obtaining no service information, and the product status identification and/or analysis information.

Thus, when the after-sales server 105 receives the product status identification and/or analysis information transmitted by the server, related personnel may obtain a corresponding solution (i.e., service information) based on these information, and store the solution in the server 104 to update the service information stored in the database of the server 104. In addition, it is also possible for the after-sales server 105 to return the solution to the sever 104. Which manner is used can be decided upon actual situations.

Thus, in the present embodiment, after the server 104 has transmitted the product status identification and/or the analysis information, the method can further comprise: the server 104 updates stored data information according to the solution received from the after-sales server 105.

Hereinafter, the method for obtaining indication information of embodiments of the present invention will be described in detail with reference to the system according to embodiments 1-3. Explanation will be made by taking a water heater as an example of the product device, but is not limited to a water heater, as other product devices also have similar situations.

### Embodiment 5

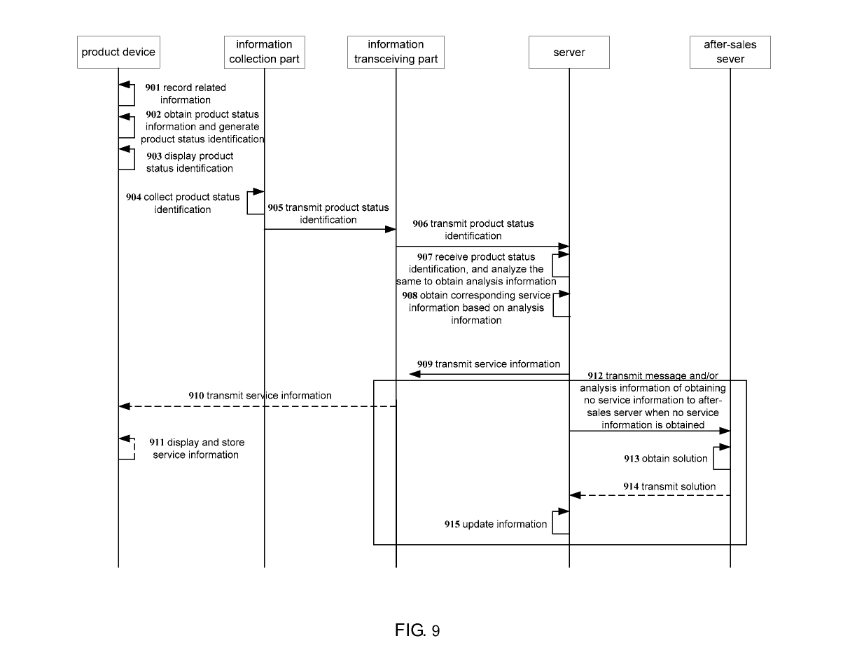

FIG. 9 is a flowchart of the method for obtaining indication information according to embodiment 5 of the present invention. Based on the system as illustrated in FIG. 1, as shown in FIG. 9, the method comprises:

Step 901, the product device records related information.

In the present embodiment, the product device may record the information before the product device leaves the factory, or is installed for a user after leaving the factory and used by the user, and the recorded information can be stored at a memory.

The specific contents of the information as recorded before the product device leaves the factory, or is installed for a user after leaving the factory and used by the user are the same as those described in embodiment 1; for example, for a water heater, the stored related information may include: parameters such as the model, number of Liter, production date, unique identifier (production identification), use time and batch number of the water heater; furthermore, the related information further comprises user usage operation information after the water heater is used, for example, temperature setting information, timing setting information, hot water consumption information, etc.

Step 902, the control part of the product device obtains the product status information and generates product status identification.

In the present embodiment, the product device generates the product status information as described in embodiment 1, based on the recorded information, and no repetition is made herein.

In the present embodiment, the product status identification can be carried using a one-dimensional code or a two-dimensional code or a three-dimensional code. Where a two-dimensional code is used, the properties thereof such as large information capacity, high safety, high read rate, and strong error correcting capability are utilized.

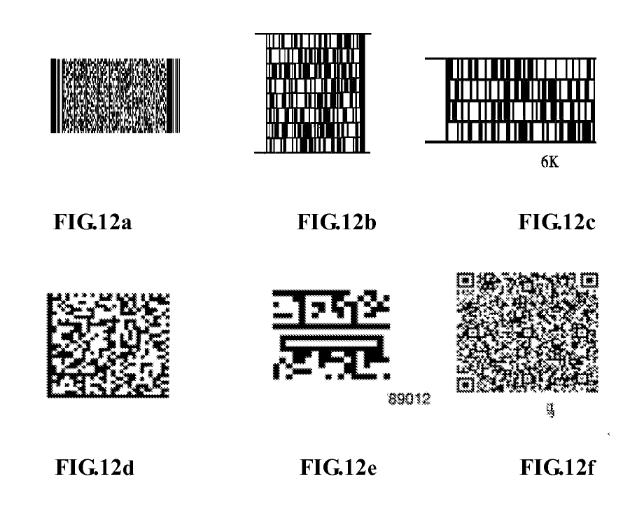

For example, a two-dimensional bar code is used as a two-dimensional code, and the two-dimensional bar codes are mainly divided into two types: stacked bar codes and matrix bar codes. FIGS. 12a to 12c are schematic diagrams of stacked two-dimensional bar codes. The coding principle of the stacked two-dimensional bar codes is established on a one-dimensional bar code, and the one-dimensional bar code is stacked into two rows or multiple rows upon requirements, for example, a PDF417 bar code in FIG. 12a, a CODE49 bar code as shown in FIG. 12b, a CODE 16K bar code as shown in FIG. 12c. FIGS. 12d to 12f are schematic diagrams of representative matrix two-dimensional bar codes, for example, a Code One bar code as shown in FIG. 12d, a Data Matrix bar code as shown in FIG. 12e, and a QR bar code as shown in FIG. 12f.

The aforementioned bar codes are merely listed as examples, and should not be understood as the restriction on the bar codes applied in the solutions of the present invention.

Explanation can be made by selecting a QR bar code as an example. As compared with other two-dimensional bar codes, the QR code has merits of fast read rate, high data density and small footprint. The QR code has three image-seeking graphs at three corners thereof, the position, size, angle of inclination of the code is detected using a CCD read apparatus to realize high speed read of 360 degree. 30 QR code symbols containing 100 characters can be read per second. As for a 417 code symbol containing the same data information, only three of them can be read per second; as for a Data Matrix code, only two to three symbols thereof can be read per second. The QR code capacity has a high density, in which 1817 Chinese characters, 7089 numerals, and 4200 English alphabets can be placed. A Chinese character can be represented by a QR code using a data compressing manner, and one Chinese character can be represented by 13 bits only. However, a two-dimensional code such as the 417 code, Data Matrix code does not have special Chinese character representation mode, so a Chinese character is merely represented using a byte representation mode. When a Chinese character is represented using a byte representation mode, 16 bits (two bytes) are required for representing one Chinese character. Therefore, the efficiency of representing a Chinese character is increased by the QR code by 20% than those two-dimensional bar codes. A QR code has an error correcting function of four levels, and an object still can be correctly recognized and read even if it is damaged. The error correcting capabilities are classified into: L level, about 7% data code word can be corrected; M level, about 15% data code word can be corrected; Q level, about 25% data code word can be corrected; H level, about 30% data code word can be corrected. Even if a QR code is attached onto a bending article, A QR code has strong bending resistance. Fast read can be achieved by configuring correction graphs in the QR code at regular intervals, obtaining an error between a central point of a speculative correction graph and an actual correction graph from the contour of the code. A QR code can be divided into 16 QR codes allowing for recognizing and reading a plurality of segmented codes once, and this meets the requirements on a limited printing area and a slender printing space. In addition, a micro QR code makes it possible to place 35 numerals or 9 Chinese characters or 21 English alphabets in a space of 1 cm, and this meets the requirements of a small circuit board on collecting ID numbers.

The symbol of QR Code has 40 versions ranging from Version 1 (specification: 21×21 modules) to Version 40 (177×177 modules).

Step 903: the display part of the product device displays the product status identification.

In the present embodiment, in order to well render a QR code, a 2.8 inch, 3.0 inch, 3.2 inch, 3.5 inch display screen having a resolution of 320*240 can be selected to display the QR bar code, the size and resolution of the display screen are not limited to the above, and can be randomly selected upon actual requirements, so no repetition is made here.

Step 904, the information collection part collects the product status identification.

In the present embodiment, when the information collection part is a camera, the camera can collect the displayed QR bar code.

Steps 905, 906, the information collection part transmits the product status identification to a server through the information transceiving part.

In the present embodiment, the QR bar code can be transmitted to the server over a network.

Steps 907, 908, the server receives the product status identification, analyzes the same to obtain corresponding analysis information, and obtains corresponding service information based on the analysis information.

The above Steps 907, 908 are similar to Step 804 in embodiment 4, and thus no repetition is made here.

Step 909 is similar to Step 805 as shown in FIG. 8, and thus no repetition is made here.

Step 910, the information transceiving part transmits the service information to the product device.

Step 911, the product device can display and/or store the service information.

Thus, a user of the product device can perform a corresponding operation based on the service information.

The above steps 910 and 911 are optional steps represented by dash lines.

In the present embodiment, in Step 908, if the service information is not obtained after analysis, the method can further comprise the following steps.

Step 912, a message and/or analysis information of obtaining no service information is transmitted to an after-sales server.

Thus, related personnel may obtain the above information, and perform processing timely.

Step 913, a solution is obtained based on the analysis information.

Step 914, the after-sales server returns the solution to the server.

The step is an optional step represented by a dash line; in addition, the solution can be directly inputted into the server.

Step 914, after obtaining the solution, the server updates service information stored in a database based on the solution.

### Embodiment 6

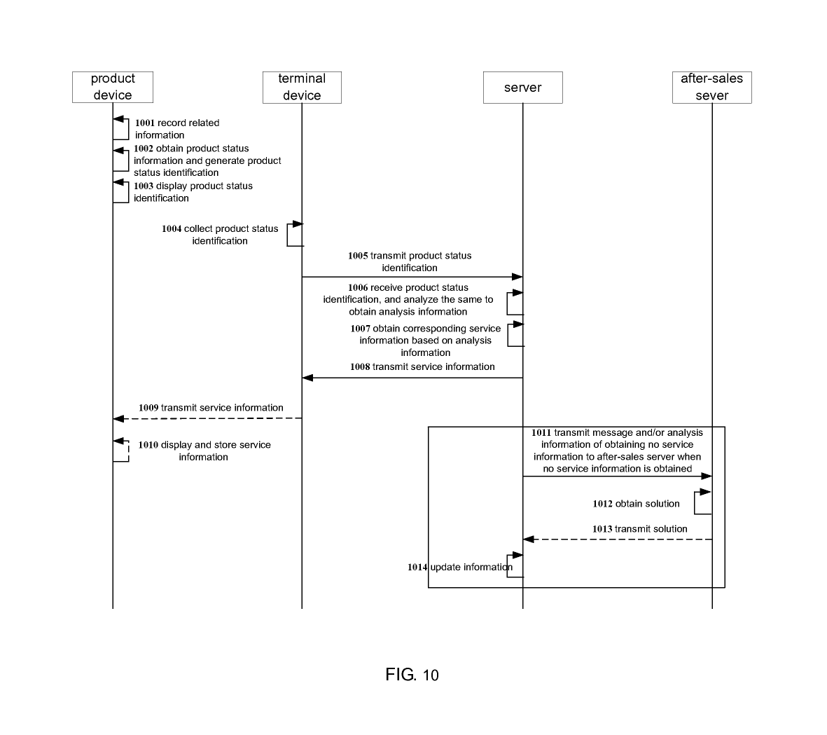

FIG. 10 is a flowchart of the method for obtaining indication information according to embodiment 6 of the present invention. Based on embodiment 5, the difference between embodiment 6 and embodiment 5 lies in arranging both the information collection part and the information transceiving part on a terminal device (e.g., mobile phone), corresponding to the system in embodiment 2. As illustrated in FIG. 10, the similarities shared between embodiment 6 and embodiment 5 are not explained herein, and differences therebetween will be described in detail.

As illustrated in FIG. 10, Steps 1001 to 1003 are identical to Steps 901-903 in embodiment 5, and thus no repetition is made here.

Steps 1006 to 1008 are similar to Steps 907-909 in embodiment 5; Step 1010 is similar to Step 911 in embodiment 5; Steps 1011 to 1014 are similar to Steps 912-915 in embodiment 5, and thus no repetition is made here.

In the present embodiment, since both the information collection part and the information transceiving part are arranged on the terminal device, steps 1004 and 1005 both are performed in the terminal device; in step 1008, the server directly returns the service information to the terminal device; in step 1009, the terminal device directly transmits the service information to the product device, by the same token, this step and step 1010 are optional.

### Embodiment 7

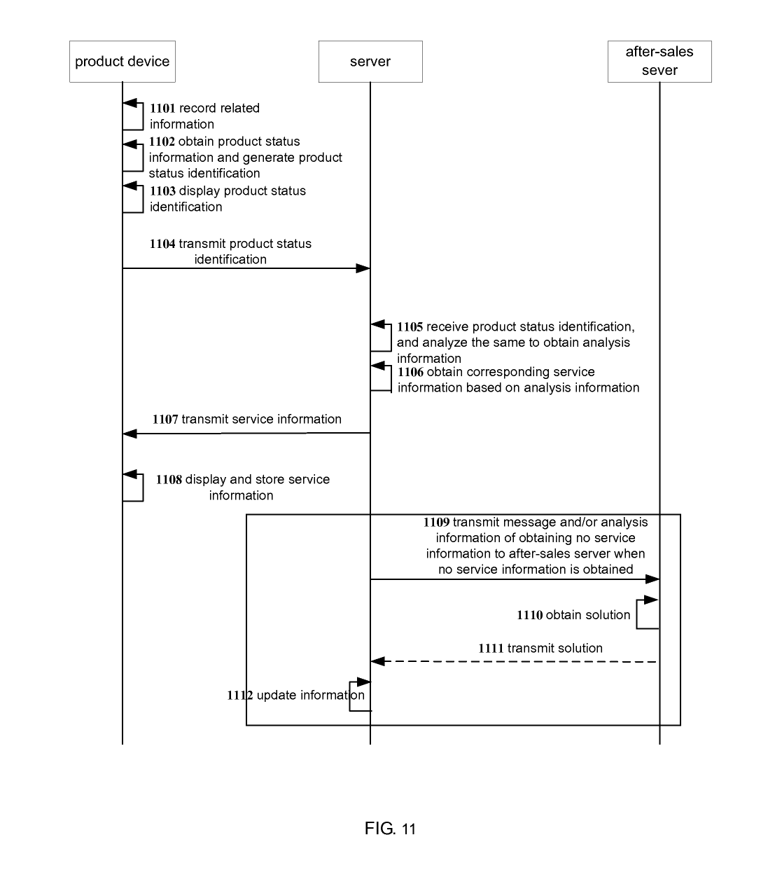

FIG. 11 is a flowchart of the method for obtaining indication information according to embodiment 7 of the present invention. Based on embodiment 5, the difference between embodiment 7 and embodiment 5 lies in arranging the information transceiving part on the product device, omitting the information collection part, corresponding to the system in embodiment 3. As illustrated in FIG. 11, similarity shared between embodiment 7 and embodiment 5 is to directly transmit the generated product status identification to the server without the need of collecting the generated product status identification. Step 1107, the server transmits the service information to the product device directly.

In the above embodiment, steps 907 and 908 as illustrated in FIG. 9, steps 1006 and 1007 as illustrated in FIG. 10 and steps 1105 and 1106 as illustrated in FIG. 11 can be used when the server obtains the service information according to the product status identification. In addition, other manners, for example, looking up corresponding service information in a database of the server according to the product status identification, can be used, to replace the above step.

As can be known from the above embodiments, by virtue of the above system, users are enabled to conveniently obtain service information in line with the use habit without the need of spending plenty of time to analyze the configuration, and with low cost.

The invention may be implemented in any suitable form including hardware, software, firmware or any combination of these. However, the invention can be selectively partially implemented, such as in the manner of computer software running on one or more data processors and/or digital signal processors. The elements and components of each of the embodiments of the invention may be physically, functionally and logically implemented in any suitable way. In fact, the functionality may be implemented in an independent unit, in a group of units or as part of other functional units. As such, the invention may be implemented in an independent unit, or may be physically and functionally distributed between different units and processors.

Persons skilled in the art will appreciate that the embodiments of the present invention may have many possible modifications and combinations. Even if their forms are slightly different, identical basic mechanism and method are still used. The foregoing description, for purpose of explanation, has been described with reference to several particular embodiments. However, the illustrative discussions above are not intended to be exhaustive or to limit the invention to the precise forms disclosed. Many modifications and variations are possible in view of the above teachings. The selected and described embodiments are used to explain the principle of the present invention and practical applications thereof, and to allow persons skilled in the art to best utilize modifications and deformations of the present invention and each of the embodiments with respect to particular applications.

What is claimed is:

1. A system for obtaining indication information, characterized in that the system comprises:
a product device, including a control part for obtaining product status information and generating a product status identification based on the same;
an information collection part, for collecting the product status identification generated by the control part;
an information transceiving part, for transmitting the product status identification collected by the information collection part to a server and receiving service information returned from the server; and
the server, including a receiving part for receiving the product status identification transmitted by the information transceiving part, an information processing part for obtaining corresponding service information according to the product status identification, and a transmitting part for returning the service information to the information transceiving part.

2. The system according to claim 1, characterized in that the product device further comprises a display part for displaying the product status identification, and/or the service information.

3. The system according to claim 2, characterized in that the display part is used for continuously or regularly displaying the product status identification, and/or the service information.

4. The system according to claim 2, wherein the product device further comprises an operation part for inputting a display instruction, wherein the display part displays the product status identification, and/or the service information according to the display instruction inputted by the operation part.

5. The system according to claim 1, wherein the information processing part comprises:
an information parsing part, for analyzing product status information according to the product status identification to obtain corresponding analysis information which includes usage habit of a user, of the product device and/or maintenance situation of the device; and
an information acquisition part, for acquiring relevant service information according to the analysis information, wherein the service information includes product usage information and/or forenotice information.

6. The system according to claim 1, characterized in that the transmitting part is further used for transmitting message and/or the analysis information of failure to obtain the service information to a post-sale service, when the corresponding service information is unavailable to the information processing part; and that
the service information further comprises an information update part for receiving inputted unavailable service information to update a database storing the service information.

7. The system according to claim 1, characterized in that the product status information includes one or more of the following information:
configuration information, usage operation information, and detection information of the product.

8. The system according to claim 1, characterized in that the product device further comprises a storage part connected with the control part for storing the product status information, and/or the product status identification, and/or the service information.

9. The system according to claim 1, characterized in that the product status identification is a one-dimensional code or a two-dimensional code or a three-dimensional code.

10. The system according to claim 1, characterized in that the information collection part and/or the information transceiving part are/is provided on the product device and connected with the control part, or are/is individual device(s).

11. The system according to claim 1, wherein the information collection part is a camera device; the information transceiving part is a terminal device; and the information collection part and the information transceiving part are individual devices.

12. The system according to claim 1, characterized in that the product device is one or more of the following devices: a water heater, an air conditioner, and a refrigerator.

13. A method for obtaining indication information, characterized in that the method comprises:
obtaining, by a control part of a product device, a product status information and generating a product status identification based on the same;
collecting, by an information collection part, the product status identification generated by the control part;
transmitting, by an information transceiving part, the product status identification to a server; and
receiving, by the server, the product status identification transmitted by the information transceiving part, and obtaining corresponding service information according to the product status identification.

14. The method according to claim 13, characterized in that the method further comprises:
displaying, by a display part of the product device, the product status identification, and/or the service information.

15. The method according to claim 13, wherein the analysis information includes usage habit of a user, of the product device and/or maintenance situation of the device, and wherein the service information includes product usage information and/or forenotice information.

16. The method according to claim 13, characterized in that the method further comprises: transmitting message and/or the analysis information of failure to obtain the service information to a post-sale service, when the corresponding service information is unavailable to the information processing part; and receiving inputted unavailable service information to update a database storing the service information.

17. The method according to claim 13, characterized in that the product status information includes one or more of the following information:
configuration information, usage operation information, and detection information of the product.

18. The method according to claim 13, characterized in that the method further comprises storing the product status information, and/or the product status identification, and/or the service information.

19. The method according to claim 13, characterized in that the product status identification is a one-dimensional code or a two-dimensional code or a three-dimensional code.

20. The system according to claim 13, characterized in that the display part is used for continuously or regularly displaying the product status identification, and/or the service information, or displaying the same according to an instruction inputted by a user.

21. A system for obtaining indication information, characterized in that the system comprises:
a product device, including a control part for obtaining product status information and generating a product status identification based on the same; and an information transceiving part, for transmitting the product status identification collected by the information collection part to a server and receiving service information returned from the server; and
a server, including a receiving part for receiving the product status identification transmitted by the information transceiving part, an information processing part for obtaining corresponding service information according to the product status identification, and a transmitting part for returning the service information to the information transceiving part.

22. A method for obtaining indication information, characterized in that the method comprises:
obtaining, by a product device, a product status information, generating a product status identification based on the same, and transmitting the product status identification to a server;
receiving, by the server, the product status identification and obtaining corresponding service information according to the product status identification; and
returning the obtained service information to the product device.
